(19) United States
(12) Patent Application Publication
(10) Pub. No.: US 2025/0205710 A1
(43) Pub. Date: Jun. 26, 2025

(54) SLIDE TRAY AND MANUFACTURING METHOD FOR SLIDE TRAY

(71) Applicant: Curiosis Inc., Seoul (KR)

(72) Inventors: Min Seop PARK, Seoul (KR); Ho Young YUN, Seoul (KR); Jae Hoon SHIN, Seoul (KR); Beom Jun LEE, Seoul (KR)

(73) Assignee: Curiosis Inc., Seoul (KR)

(21) Appl. No.: 19/076,349

(22) Filed: Mar. 11, 2025

Related U.S. Application Data
(63) Continuation of application No. PCT/KR2023/007336, filed on May 30, 2023.

(30) Foreign Application Priority Data
Sep. 16, 2022 (KR) 10-2022-0117297

(51) Int. Cl. B01L 9/00

(52) U.S. Cl. CPC B01L 9/523; B01L 2300/021; B01L 2300/0809

(57) ABSTRACT

An embodiment of the present disclosure is to provide a slide tray and a manufacturing method therefor. The slide tray comprises: a planar member; and a plurality of slide receiving portions formed on one surface of the planar member and formed as recesses that can accommodate slides, wherein the plurality of slide receiving portions are formed on the planar member at certain intervals, and the plurality of slide receiving portions may each have at least a portion formed as a hollow portion and at least a portion to which an adsorbent film is attachable.

### CROSS-REFERENCE TO RELATED APPLICATIONS

This is a continuation of International Application No. PCT/KR2023/007336 filed on May 30, 2023, which claims priority to Korean Patent Application No. 10-2022-0117297 filed on Sep. 16, 2022, the entire contents of which are herein incorporated by reference.

### TECHNICAL FIELD

The present disclosure relates to a slide tray and a method of manufacturing the same. More specifically, the present disclosure relates to a slide tray including a plurality of slide receiving portions formed as recesses capable of receiving slides and a method of manufacturing the same.

### DESCRIPTION OF THE RELATED ART

Pathology department observes and analyzes morphological changes in a patient's cells, tissues, and tissue fluids to make a diagnosis, providing a foundation for clinicians to guide treatment. In the pathology department, traditional cytology or histology examination is usually performed by a specialist using a microscope to read and diagnose a patient's cell slide or tissue slide with the naked eye, but recently, digital slide scanners have been introduced to pathology diagnosis, and in addition to pathology diagnosis using microscopy, pathology diagnosis is performed using digital images scanned from cell-stained slides or tissue-stained slides.

Slides containing a patient's specimen are received in a tray, the tray receiving the slides is transported or stored, and the slides are withdrawn by a physician, examiner, digital slide scanner, or the like to perform a pathology diagnosis. Slide trays to minimize slide handling errors, such as breakage and loss of slides, are essential in the diagnosis of these pathologies. The slide tray should hold the slides to prevent breakage or loss during storage or transportation, and should easily release when external forces are applied to withdraw the slides from the slide tray by a physician, examiner, digital slide scanner and the like. However, currently existing slide trays either do not have sufficient holding power, require excessive external force to release the slide, or require too many parts to achieve sufficient holding power and easy withdrawal. The present disclosure is intended to address these problems.

### SUMMARY OF THE INVENTION

### Technical Goals

One example embodiment of the present disclosure is intended to provide a slide tray and a method of manufacturing the same.

### Technical Solutions

One example embodiment of the present disclosure seeks to provide a slide tray and a method of manufacturing the same for minimizing slide handling errors, such as breakage and loss of slides.

One example embodiment of the present disclosure seeks to provide a slide tray that provides sufficient holding power for slides and allows for easy release.

One example embodiment of the present disclosure seeks to provide a slide tray including: a planar member; and a plurality of slide receiving portions formed on one surface of the planar member, formed as recesses for receiving slides. The plurality of slide receiving portions are formed at predetermined intervals on the planar member, and wherein each of the plurality of slide receiving portions is formed, at least in part, as a hollow portion, and an absorbent film is attached to at least a portion thereof.

In one example embodiment, the adsorbent film may include at least one of an electrostatic force film, a porous adsorbent film, a film utilizing Van der waals force, a covalent force film, and an adhesive film.

In one example embodiment, the adsorbent film may include a base of a polymer-based material and a coating layer including a resin material.

In one example embodiment, the adsorbent film may be attached to at least a portion of the one surface of the plurality of slide receiving portions excluding the hollow portion.

In one example embodiment, the hollow portion includes a first hollow portion for lifting a slide received in the slide receiving portion from the slide receiving portion, and when the slide is received on one surface of the slide receiving portion by the adsorbent film, a first region of the first hollow portion may be covered with the slide, and a second region of the first hollow portion may be exposed.

In one example embodiment, the hollow portion includes a second hollow portion, and when the slide is received on one surface of the slide receiving portion by the adsorbent film, the entire area of the second hollow portion may be covered with the slide.

In one example embodiment, the planar member may be marked with at least one of identification information for the slide tray, reference orientation information for inserting the slide tray into a slide scanner, and identification information for each of the plurality of slide receiving portions.

In one example embodiment, the slide received in the slide receiving portion includes specimen information generated using at least one of numbers, letters, a quick response code (QR code), and a barcode. The specimen information may correspond to at least one of a subject's name, gender, age, medical history, and information about the specimen.

One example embodiment of the present disclosure provides a method of manufacturing a slide tray. The method of manufacturing the slide tray may include: producing a planar member; producing a plurality of slide receiving portions formed as recesses for receiving slides, at predetermined intervals, on one surface of the planar member; forming a hollow portion in at least a portion of each of the plurality of slide receiving portions; and attaching an absorbent film to at least a portion of the plurality of slide receiving portions.

In one example embodiment, the adsorbent film may include at least one of an electrostatic force film, a porous adsorbent film, a film utilizing Van der waals force, and a covalent force film, and an adhesive film.

In one example embodiment, the adsorbent film may include a base of a polymer-based material and a coating layer including a resin material.

In one example embodiment, the adsorbent film may be attached to at least a portion of the one surface of the plurality of slide receiving portions, excluding the hollow portion.

In one example embodiment, the hollow portion includes a first hollow portion for lifting a slide received in the slide receiving portion from the slide receiving portion, and when the slide is received on one surface of the slide receiving portion by the adsorbent film, a first region of the first hollow portion may be covered with the slide, and a second region of the first hollow portion may be exposed.

In one example embodiment, the hollow portion includes a second hollow portion, and when the slide is received on one surface of the slide receiving portion by the adsorbent film, the entire area of the second hollow portion may be covered with the slide.

In one example embodiment, the planar member may be marked with at least one of identification information for the slide tray, reference orientation information for inserting the slide tray into a slide scanner, and identification information for each of the plurality of slide receiving portions.

In one example embodiment, the slide received in the slide receiving portion includes specimen information generated using at least one of numbers, letters, a quick response code (QR code), and a barcode. The specimen information may correspond to at least one of a subject's name, gender, age, medical history, and information about the specimen.

### Effects

According to one example embodiment of the present disclosure, slide handling errors, such as breakage and loss of slides, may be minimized.

Further, one example embodiment of the present disclosure may provide a slide tray that has sufficient holding power for slides and allows for easy release, thereby contributing to providing a more efficient pathology system.

### BRIEF DESCRIPTION OF THE DRAWINGS

FIG. 1 is a diagram illustrating a slide tray, according to one example embodiment of the present disclosure.

FIG. 2 is a diagram illustrating an example of a slide tray with a film having an adsorbent property, according to one example embodiment of the present disclosure.

FIG. 3 is a diagram illustrating an example of a slide tray with a film having an adsorbent property, according to one example embodiment of the present disclosure.

FIG. 4 is a diagram illustrating a slide tray with a slide received, according to one example embodiment of the present disclosure.

### DETAILED DESCRIPTION

In order to clarify the technical ideas of the present disclosure, example embodiments of the present disclosure are described in detail with reference to the accompanying drawings. In describing the present disclosure, specific descriptions of relevant disclosed features or components will be omitted if it is determined that such detailed description would unnecessarily obscure the main idea of the disclosure. In the drawings, components having substantially the same functional configuration are given the same reference numerals and symbols wherever possible, even if they are shown in different drawings. For ease of description, apparatus and methods are described together where necessary. The operations of the present disclosure need not necessarily be performed in the order described and may be performed in parallel, optionally, or individually.

The terminology used in the example embodiments of the present disclosure has been chosen to be as generic as possible in current common usage while considering the features of the disclosure, but may vary according to the intent or precedent of those skilled in the art, the emergence of new technologies, and the like. In addition, in certain instances, terms are arbitrarily chosen by the applicant, in which case their meaning will be described in detail in the description of the applicable example embodiments. Accordingly, terms used herein are to be defined based on their meaning and the context of the disclosure as a whole, rather than on the mere designation of the term.

Throughout this disclosure, expressions in the singular may include the plural unless the context clearly indicates otherwise. The terms “comprising” or “having” and the like are intended to designate the presence of a feature, number, step, action, component, part, or combination thereof, and are not intended to preclude the possibility of the presence or addition of one or more other features, numbers, steps, actions, components, parts, or combinations thereof. In other words, throughout this disclosure, when we say that a part “includes” a component, we mean that it may further include other components, not exclude other components, unless specifically stated to the contrary.

Expressions such as “at least one” express the entire list of components, not the components of the list individually. For example, “at least one of A, B, and C” and “at least one of A, B, or C” refer to only A, only B, only C, both A and B, both B and C, both A and C, both A and B and C, or any combination thereof.

In addition, the terms “ . . . part,” “ . . . module,” and the like as used herein refer to a unit that handles at least one function or operation, which may be implemented in hardware or software, or a combination of hardware and software.

Throughout this disclosure, when a part is to be “connected” to another part, this includes not only when it is “directly connected” but also when it is “electrically connected” with another element in between. Also, when a part is to “include” another part, it is meant to be inclusive of the other part, not exclusive of the other part, unless specifically stated to the contrary.

As used throughout this disclosure, the expression “configured to” may be used interchangeably with, for example, “suitable for,” “having the capacity to,” “designed to,” “adapted to,” “made to,” or “capable of,” depending on the context. The term “configured (or set up) to” may not necessarily mean “specifically designed to” in the form of hardware. Instead, in some situations, the phrase “system configured to” may mean that the system “can” do something in conjunction with other devices or components. For example, the phrase “a processor configured (or set) to perform A, B, and C” may refer to a dedicated processor (for example, an embedded processor) for performing those actions, or a generic-purpose processor (for example, a central processing unit (CPU) or application processor) that may perform those actions by executing one or more software programs stored in memory.

Throughout this disclosure, a slide is a thin, flat piece of glass used to hold a specimen, and may include a slide glass, a glass slide, a microscope slide, a specimen placed on a slide glass and covered with a cover glass, and the like. Of course, it is not limited to the above examples.

Throughout this disclosure, a slide tray is a case for transporting or storing slides and may also be referred to as a tray, glass plate, slide plate, slide holder, glass holder, slide case, glass case, slide folder, glass folder, and the like.

As used throughout this disclosure, adsorptive property may refer to the property of adhesion of atoms, ions, or molecules from a gas, liquid, or dissolved solid to a surface. In one example embodiment, adsorptive property may include physical adsorption characterized by weak van der Waals forces, chemical adsorption characterized by covalent bonds, electrostatic adsorption characterized by electrostatic attraction, and may further include tackiness.

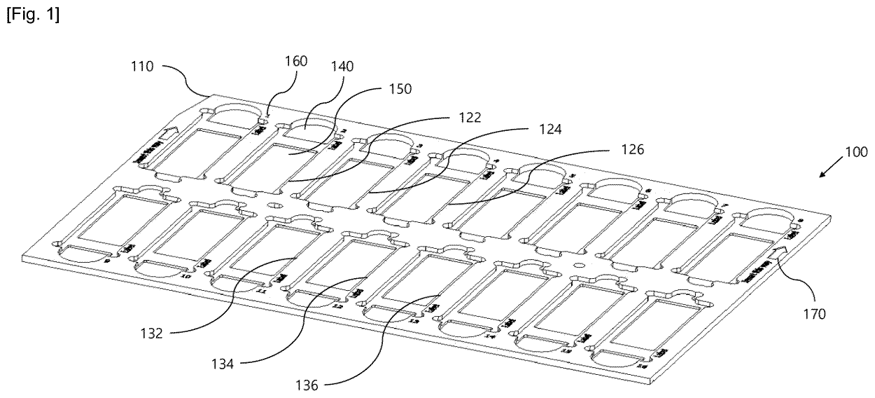

FIG. 1 is a diagram illustrating a slide tray, according to one example embodiment of the present disclosure.

Referring to FIG. 1, the slide tray 100 may include a planar member 110. Further, one surface of the planar member 110 may have a plurality of slide receiving portions formed as recesses for receiving slides. For example, the plurality of slide receiving portions may include a first slide receiving portion 122, a second slide receiving portion 124, a third slide receiving portion 126, a fourth slide receiving portion 132, a fifth slide receiving portion 134, a sixth slide receiving portion 136, and the like. In one example embodiment, the plurality of slide receiving portions may be in the form of a recess formed in the planar member 110 that is at least as thick as the slide.

In one example embodiment, the plurality of slide receiving portions may be formed at predetermined intervals on the planar member 110. For example, using the slide tray 100 of FIG. 1 as an example, the planar member 110 of the slide tray 100 has a rectangular shape, and eight slide receiving portions, including the first slide receiving portion 122, the second slide receiving portion 124, and the third slide receiving portion 126, may be formed in the first row of the planar member 110 at predetermined intervals, and another eight slide receiving portions, including the fourth slide receiving portion 132, the fifth slide receiving portion 134, and the sixth slide receiving portion 136, may be formed in a second row that differs from the first row at predetermined intervals. Further, the slide receiving portions formed in the first row and the slide receiving portions formed in the second row may be spaced apart at a predetermined interval. However, this is only an example, and various variations are possible, including, but not limited to, the number of slide receiving portions included in the slide tray 100, the shape of the planar member 110, and the shape in which the plurality of slide receiving portions are formed at predetermined intervals.

In one example embodiment, each of the plurality of slide receiving portions may be at least partially formed as a hollow portion. For example, the first slide receiving portion 122 may be formed with a first hollow portion 140 and a second hollow portion 150. Alternatively, only the first hollow portion 140 may be formed in the first slide receiving portion 122. However, this is only an example and each of the plurality of slide receiving portions may include at least one of a hollow portion corresponding to the first hollow portion 140 and a hollow portion corresponding to the second hollow portion 150, or may include additional hollow portions other than the first hollow portion 140 and the second hollow portion 150. According to one example embodiment, the first hollow portion 140 is a hollow portion for lifting a slide received in the slide receiving portion, and a user of the slide tray 100 may use the first hollow portion 140 to comfortably lift a slide loaded into the slide tray 100. Accordingly, the first hollow portion 140 may correspond to a hole of a size that is comfortable for a human finger to grip the slide. In one example embodiment, the first hollow portion 140 may include an outer curved surface. For example, the first hollow portion 140 may have a shape consisting of a circle, a semicircle, or a portion of a circumference and a straight line, and the like.

In one example embodiment, at least a portion of each of the plurality of slide receiving portions may have an adsorbent film (not shown) attached to the slide receiving portions so that the slides are removable. When a slide is received in a slide receiving portion, the adsorbent film may serve to fix the relative position of the slide and the slide receiving portion. When a slide is received in a slide receiving portion, a bonding force between the slide and the slide receiving portion may be created by an adsorbent film. For example, the bonding force between the slide and the slide receiving portion may be intermolecular and may include electrostatic forces.

In one example embodiment, the adsorbent film may include an electrostatic force film, a porous adsorbent film, a film utilizing Van der waals force, a covalent force film, an adhesive film, or the like. For example, if a porous adsorbent film is utilized, the slide may be received in the slide receiving portion by vacuum adsorption through the porous material between the slide and the slide receiving portion. Furthermore, an example of an adhesive film may be an adhesive tape.

According to one example embodiment, by using an adsorbent film to increase the holding force between the slide tray and the slide, the slide may not require an energy supply other than a moderate external force to lift the slide. This may reduce the cost of manufacturing the slide trays by eliminating the need for springs, electrical wiring, air piping, and other equipment.

In one example embodiment, the adsorbent film may include a base of a polymer-based material and a coating layer consisting of a resin material. According to one example embodiment, the coating layer consisting of a resin material may enable repeated use of the slide tray. Furthermore, if the adsorbent film loses its adsorption capacity after many repeated uses, the adsorbent film may be replaced with a new one.

In one example embodiment, the first hollow portion 140 may be a hollow portion for lifting a slide received in the first slide receiving portion 122 out of the first slide receiving portion 122. When a slide is received on one surface of the first slide receiving portion 122, some areas of the first hollow portion 140 may be covered with the slide in an orientation orthogonal to the one surface of the planar member 110, and other areas may be exposed in an orientation orthogonal to the one surface of the planar member 110. Further, if a slide is received on one surface of the first slide receiving portion 122, the entire area of the second hollow portion 150 may be covered with the slide.

In one example embodiment, the planar member 110 may display identification information for the slide tray 100, reference orientation information 170 for inserting the slide tray into the slide scanner, identification information 160 for the slide receiving portion, and the like. For example, the identification information for the slide tray 100 may include a serial number of the slide tray 100, the identification information for the slide receiving portions may include an identification number indicating a sequence of the slide receiving portions, and the like. In one example embodiment, a slide scanner may be equipment that scans slides received in the slide tray 100 into high-resolution digital images. The slide scanner may also be referred to as a digital slice scanner, and may automatically scan a plurality of slides to create virtual slide images.

According to one example embodiment, the slide tray 100 may include identification information for the slide tray, reference orientation information 170 for insertion into a slide scanner, and the like, to provide information that may facilitate analysis of the slides received in the slide tray.

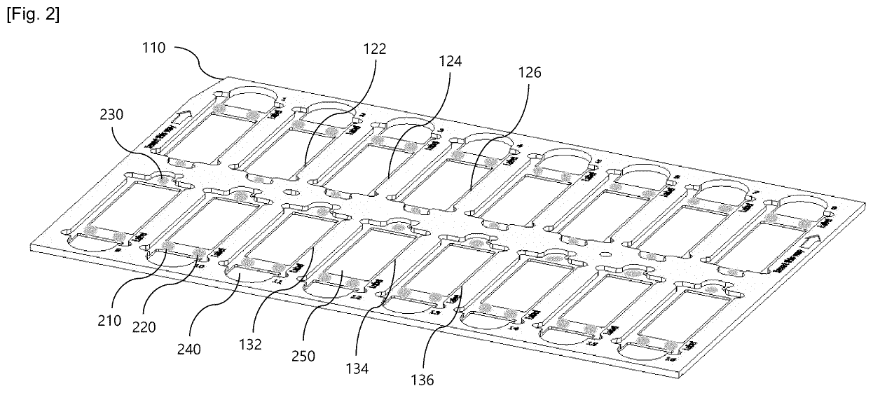

FIG. 2 is a diagram illustrating an example of a slide tray with a film having an adsorbent property, according to one example embodiment of the present disclosure.

Referring now to FIG. 2, a slide tray 100 may be provided having adsorbent films 210, 220, 230 attached to at least a portion of a plurality of slide receiving portions. Referring to a fourth slide receiving portion 132 as an example, the adsorbent film 210, 220, 230 may be attached to at least a portion of a region other than the hollow portions 240, 250 of the slide receiving portions. Similarly, an absorbent film may be attached to each of the plurality of slide receiving portions, including the first slide receiving portion 122 to the sixth slide receiving portion 136. For example, the adsorbent films 210, 220, 230 may be attached to a plurality of areas. Further, the adsorbent films 210, 220, 230 may be in the shape of a circle. However, this is an example only, and the adsorbent films 210, 220, 230 may be shaped other than circular, or may be attached to only one area, or may be attached to all areas except the hollow portions 240, 250 of the slide receiving portions 132.

In one example embodiment, the method of manufacturing the slide tray 100 may include both a method of manufacturing the slide tray 100 with the adsorbent film 210, 220, 230 attached and a method of manufacturing the adsorbent film and the slide tray 100 without the adsorbent film attached. In other words, the manufacturer of the slide tray 100 may produce both a slide tray with an adsorbent film and a slide tray without an adsorbent film, sell it to a consumer, and then have the consumer attach the adsorbent film to the slide tray for use.

While various devices such as springs, clips, and the like have been previously required to hold slides to a slide tray, one example embodiment utilizes an adsorbent film to reduce the cost of producing a slide tray that has a holding power on slides.

Further, according to one example embodiment, the slide may be simply held to the slide tray by holding the slide to the slide using an absorbent film, and the slide may be easily released from the slide tray as needed.

In one example embodiment, the adsorbent film is coated using a special resin to hold and release the slides to the slide tray, allowing the user to use the slide tray repeatedly.

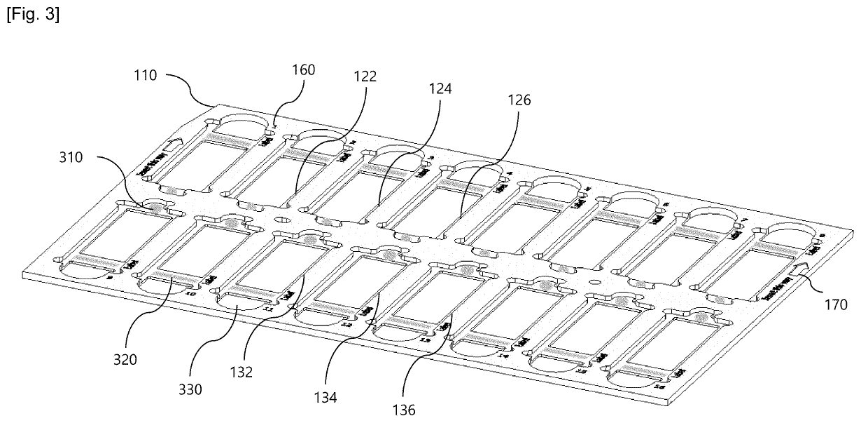

FIG. 3 is a diagram illustrating an example of a slide tray with a film having an adsorbent property, according to one example embodiment of the present disclosure.

Referring now to FIG. 3, a slide tray 100 may be provided having adsorbent films 310, 320 attached to at least a portion of a plurality of slide receiving portions. Referring to a fourth slide receiving portion 132 as an example, the adsorbent films 310, 320 may be attached to at least a portion of a region other than the hollow portion 330 of the slide receiving portion. Similarly, an absorbent film may be attached to each of the plurality of slide receiving portions, including the first slide receiving portion 122 to the sixth slide receiving portion 136. The first adsorbent film 310 and the second adsorbent film 320 may have different shapes. For example, the first adsorbent film 310 may have a circular shape and the second adsorbent film 320 may have a rectangular shape. However, this is an example and is not limited thereto, and the adsorbent films attaching to the slide receiving portions may have the same or different shapes, and may be shaped in various ways, such as circles, semicircles, rectangles, polygons, shapes with rounded corners, and the like.

The description with reference to FIGS. 2 and 3 is by way of illustration that the plurality of slide receiving portions may have various shapes and various numbers of films attached thereto, and is not intended to be limiting as to how the films may be attached. Any suitable number and shape of films may be attached to any suitable location on the slide receiving portions, taking into account the appropriate amount of external force required to provide sufficient holding power of the slide and ease of release.

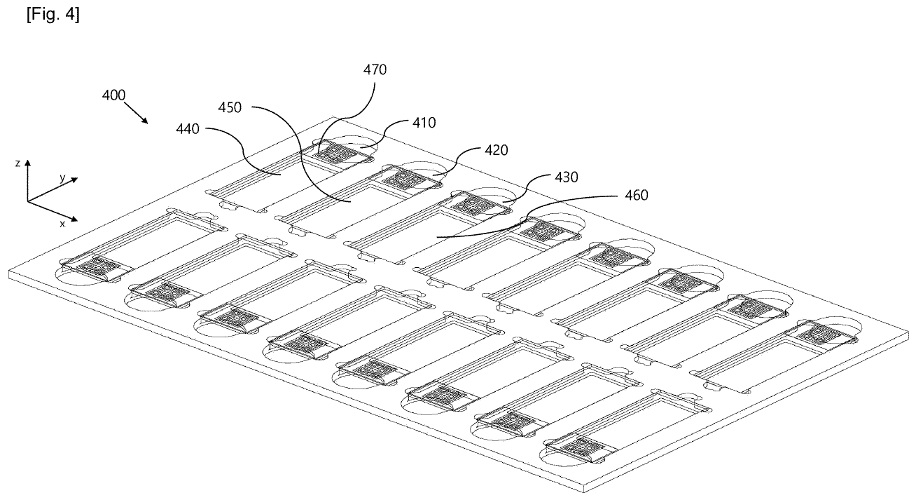

FIG. 4 is a diagram illustrating a slide tray with a slide received, according to one example embodiment of the present disclosure.

Referring now to FIG. 4, there is shown a slide tray 400 having slides 440, 450, 460 received in a plurality of slide receiving portions. The slide tray 400 may correspond to the slide tray 100 described above with reference to FIGS. 1 through 4. In one example embodiment, the slides 440, 450, 460 may each be received in corresponding slide receiving portions. The slide receiving portions may have a width (length along the x-axis) and a height (length along the z-axis) of the recess that corresponds to the width (length along the x-axis) and thickness (length along the z-axis) of the slide to properly receive the slide 440, 450, 460. However, the length along the y-axis of the recess corresponding to the slide receiving portion may be at least partially formed to be longer than the longitudinal length (length along the y-axis) of the slide. Accordingly, a user of the slide tray 400 may easily lift the slides 440, 450, 460 from the slide receiving portions by utilizing the gaps 410, 420, 430 between the slide receiving portions and the slides. For example, the user may insert a portion of a finger into the gap 410, 420, 430 between the slide receiving portion and the slide to lift the slide 440, 450, 460.

In one example embodiment, the slide 440 may include specimen information 470 generated using at least one of numbers, letters, quick response codes (QR codes), and barcodes. Further, the specimen information may correspond to at least one of a subject's name, gender, age, medical history, and information about the specimen.

In one example embodiment, the specimen information 470 may be used when the slide tray 400 is transported to a slide scanner and scanned by a slide scanner. For example, the slide scanner may scan the specimen included in the slide 440 while simultaneously scanning the specimen information 470 included in the slide 440 to identify which subject's specimen it is, and may map the scanned specimen to the specimen information 470 and store it. Furthermore, if the specimen information 470 includes the subject's medical history, the slide scanner may map the specimen information 470, including the subject's medical history, to the scanned specimen to help a person performing a pathology diagnosis make a more accurate pathology diagnosis.

The foregoing description of the present disclosure is for illustrative purposes only, and those having ordinary knowledge in the technical field to which the present disclosure belongs will understand that it may be readily adapted to other specific forms without altering the technical idea or essential features of the invention. The example embodiments described above are therefore to be understood in all respects as exemplary and not limiting. For example, each component described in a single form may be implemented in a distributed manner, and similarly, components described as distributed may be implemented in a combined form.

The scope of this disclosure is indicated by the following patent claims rather than by the detailed description above, and all modifications or variations derived from the meaning and scope of the claims and the equivalents thereof shall be construed to be within the scope of this disclosure.

What is claimed is:

1. A slide tray, comprising:
a planar member; and
a plurality of slide receiving portions formed on one surface of the planar member, formed as recesses for receiving slides,
wherein the plurality of slide receiving portions are formed on the planar member at predetermined intervals, and
wherein each of the plurality of slide receiving portions is formed as a hollow portion at least in part, and an adsorbent film is attached to at least a portion thereof.

2. The slide tray of claim 1, wherein the adsorbent film comprises at least one of an electrostatic force film, a porous adsorbent film, a film utilizing Van der waals force, a covalent force film, and an adhesive film.

3. The slide tray of claim 1, wherein the adsorbent film comprises a base of a polymer-based material and a coating layer comprising a resin material.

4. The slide tray of claim 1, wherein the adsorbent film is attached to at least a portion of the one surface of the plurality of slide receiving portions excluding the hollow portion.

5. The slide tray of claim 1, wherein the hollow portion comprises a first hollow portion for lifting a slide received in the slide receiving portion from the slide receiving portion, and when the slide is received on one surface of the slide receiving portion by the adsorbent film, a first region of the first hollow portion is covered with the slide, and a second region of the first hollow portion is exposed.

6. The slide tray of claim 1, wherein the hollow portion comprises a second hollow portion, and when the slide is received on one surface of the slide receiving portion by the adsorbent film, an entire area of the second hollow portion is covered with the slide.

7. The slide tray of claim 1, wherein the planar member is marked with at least one of identification information for the slide tray, reference orientation information for inserting the slide tray into a slide scanner, and identification information for each of the plurality of slide receiving portions.

8. The slide tray of claim 1, wherein the slide received in the slide receiving portion comprises specimen information generated using at least one of numbers, letters, a quick response code (QR code), and a barcode, and wherein the specimen information corresponds to at least one of a subject's name, gender, age, medical history, and information about the specimen.

9. A method of manufacturing a slide tray, the method comprising:
producing a planar member;
producing a plurality of slide receiving portions formed as recesses for receiving slides, at predetermined intervals, on one surface of the planar member;
forming a hollow portion in at least a portion of each of the plurality of slide receiving portions; and
attaching an absorbent film to at least a portion of the plurality of slide receiving portions.

10. The method of claim 9, wherein the adsorbent film comprises at least one of an electrostatic force film, a porous adsorbent film, a film utilizing Van der waals force, a covalent force film, and an adhesive film.

11. The method of claim 9, wherein the adsorbent film comprises a base of a polymer-based material and a coating layer comprising a resin material.

12. The method of claim 9, wherein the adsorbent film is attached to at least a portion of the one surface of the plurality of slide receiving portions excluding the hollow portion.

13. The method of claim 9, wherein the hollow portion comprises a first hollow portion for lifting a slide received in the slide receiving portion from the slide receiving portion, and when the slide is received on one surface of the slide receiving portion by the adsorbent film, a first region of the first hollow portion is covered with the slide, and a second region of the first hollow portion is exposed.

14. The method of claim 9, wherein the hollow portion comprises a second hollow portion, and when the slide is received on one surface of the slide receiving portion by the adsorbent film, the entire area of the second hollow portion is covered with the slide.

15. The method of claim 9, wherein the planar member is marked with at least one of identification information for the slide tray, reference orientation information for inserting the slide tray into a slide scanner, and identification information for each of the plurality of slide receiving portions.

16. The method of claim 9, wherein the slide received in the slide receiving portion comprises specimen information generated using at least one of numbers, letters, a quick response code (QR code), and a barcode, and wherein the specimen information corresponds to at least one of a subject's name, gender, age, medical history, and information about the specimen.
